(19) United States
(12) Patent Application Publication
(10) Pub. No.: US 2020/0143414 A1
(43) Pub. Date: May 7, 2020

(54) Automated Advertisement Selection Using a Trained Predictive Model

(71) Applicant: Disney Enterprises, Inc., Burbank, CA (US)

(72) Inventors: Binbin Li, Redondo Beach, CA (US); Amanda Conrad, Van Nuys, CA (US); Simon Asselin, Sammamish, WA (US); Jamie Auslander, Los Angeles, CA (US); Joshua Rangsikitpho, Malibu, CA (US); Zhenyu Shi, Los Angeles, CA (US); Alexander Vondrak, Los Angeles, CA (US)

(21) Appl. No.: 16/669,397

(22) Filed: Oct. 30, 2019

Related U.S. Application Data
(60) Provisional application No. 62/755,347, filed on Nov. 2, 2018.

(51) Int. Cl. G06Q 30/02; G06N 3/08; G06K 9/62

(52) U.S. Cl. CPC G06Q 30/0243; G06Q 30/0204; G06K 9/6257; G06Q 30/0251; G06Q 30/0201; G06N 3/08

(57) ABSTRACT

An automated advertisement selection system includes a computing platform having a hardware processor and a system memory storing a software code including a trained predictive model and a scoring module. The hardware processor executes the software code to receive an advertising query, the advertising query including a multiple parameters describing a target consumer group, and to identify, using the trained predictive model, candidate advertisements for the target consumer group based on the multiple parameters. The hardware processor also executes the software code to determine, using the scoring module, desirability scores for each one of the plurality of candidate advertisements, each of the desirability scores corresponding to a likelihood of each respective one of the plurality of candidate advertisements enticing the target consumer group, and to select one of the plurality of candidate advertisements based on the desirability scores for distribution to the target consumer group.

### RELATED APPLICATIONS

The present application claims the benefit of and priority to a pending Provisional Patent Application Ser. No. 62/755,347, filed Nov. 2, 2018, and titled “Methods and Systems for Advertisement Serving Decision Utilizing Online Scoring for Brand Lift Measurement,” which is hereby incorporated fully by reference into the present application.

### BACKGROUND

Advertising campaign strategies are increasingly reliant on the collection of vast amounts of data regarding potential customers to determine when and where to target advertisements in order to best ensure a successful campaign. Such large data collections are often referred to simply as “big data,” which is an expression defined, for example, by the online encyclopedia Wikipedia® as “data sets that are so voluminous and complex that traditional data-processing application software are inadequate to deal with them.”

Due to its very volume, big data can be difficult to analyze and use effectively in shaping an advertising strategy. For example, while a consumer may be expected to align according to traditional metrics such as age group, geography, or other demographic criteria identifiable through the filtering of big data, an advertisement targeted to the consumer based on those metrics may yet be received with indifference or even hostility. However, failure to consistently target consumers with advertising that is appealing to them can undesirably reduce the anticipated return on investment (ROI) of the advertising campaign, and may even compromise the overall success of the campaign.

### SUMMARY

There are provided systems and methods for automating advertisement selection using a predictive model, substantially as shown in and/or described in connection with at least one of the figures, and as set forth more completely in the claims.

### BRIEF DESCRIPTION OF THE DRAWINGS

FIG. 1 shows a diagram of an exemplary system for automating advertisement selection using a predictive model, according to one implementation;

FIG. 2 shows a diagram of an exemplary software code for automating advertisement selection using a predictive model, according to one implementation;

FIG. 3A shows a flowchart presenting an exemplary method for use by a system for automating advertisement selection using a predictive model, according to one implementation; and

FIG. 3B shows a flowchart presenting an extension of the exemplary method outlined in FIG. 3A, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for automating advertisement selection using a predictive model that overcome the drawbacks and deficiencies in the conventional art. It is noted that, as used in the present application, the terms “automation,” “automated”, and “automating” refer to systems and processes that do not require human intervention. Although, in some implementations, a human system administrator may review or even modify advertising selections made by the systems and according to the methods described herein, that human involvement is optional. Thus, the advertisement selection described in the present application may be performed under the control of hardware processing components executing them.

It is further noted that as defined in the present application, the feature “trained predictive model” (also “machine learning model”) refers to a mathematical model for making future predictions based on patterns learned from samples of data or “training data.” Various learning algorithms can be used to map correlations between input data and output data. These correlations form the mathematical model that can be used to make future predictions on new input data.

Moreover, as defined in the present application, an artificial neural network (hereinafter “ANN”), also known simply as a neural network (NN), is a type of machine learning framework in which patterns or learned representations of observed data are processed using highly connected computational layers that map the relationship between inputs and outputs. A “deep neural network,” in the context of deep learning, may refer to a neural network that utilizes multiple hidden layers between input and output layers, which may allow for learning based on features not explicitly defined in raw data.

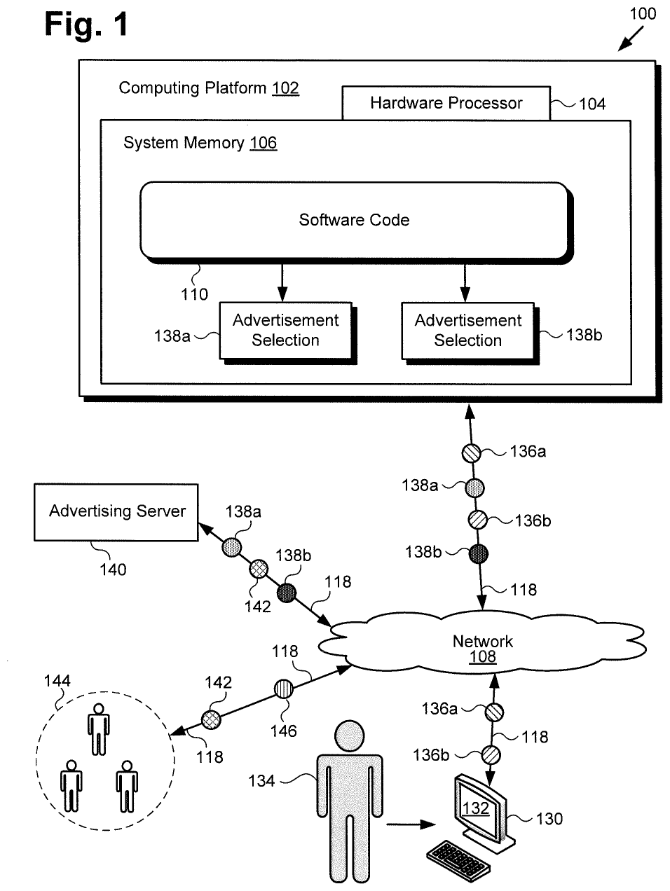

FIG. 1 shows a diagram of an exemplary system for automating advertisement selection using a predictive model, according to one implementation. As shown in FIG. 1, system 100 includes computing platform 102 having hardware processor 104, and system memory 106 implemented as a non-transitory storage device. According to the exemplary implementation shown in FIG. 1, system memory 106 stores software code 110 used to automate selection of advertisements for distribution to target consumer group 144.

As further shown in FIG. 1, system 100 may be implemented in a user environment including advertisement server 140 and user system 130 communicatively coupled to system 100 via communication network 108 and network communication links 118. In addition, FIG. 1 shows user 134 utilizing user system 130 to submit first advertising query 136a and second advertising query 136b to system 100, as well as first advertisement selection 138a and second advertisement selection 138b output by software code 110. Also shown in FIG. 1 are advertisement 142 distributed to target consumer group 144 based on first advertisement selection 138a, consumer rating 146 of advertisement 142 by at least some members of target consumer group 144, and display 132 of user system 130. In some implementations, system 100 may be configured to provide first advertisement selection 138a and/or second advertisement selection 138b in real-time with respect to receiving respective first advertising query 136a and/or second advertising query 136b from user 134.

With respect to the representation of system 100 shown in FIG. 1, it is noted that although software code 110 is depicted as being stored in system memory 106 for conceptual clarity, more generally, system memory 106 may take the form of any computer-readable non-transitory storage medium. The expression “computer-readable non-transitory storage medium,” as used in the present application, refers to any medium, excluding a carrier wave or other transitory signal that provides instructions to a hardware processor of a computing platform, such as hardware processor 104 of computing platform 102. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM), and FLASH memory.

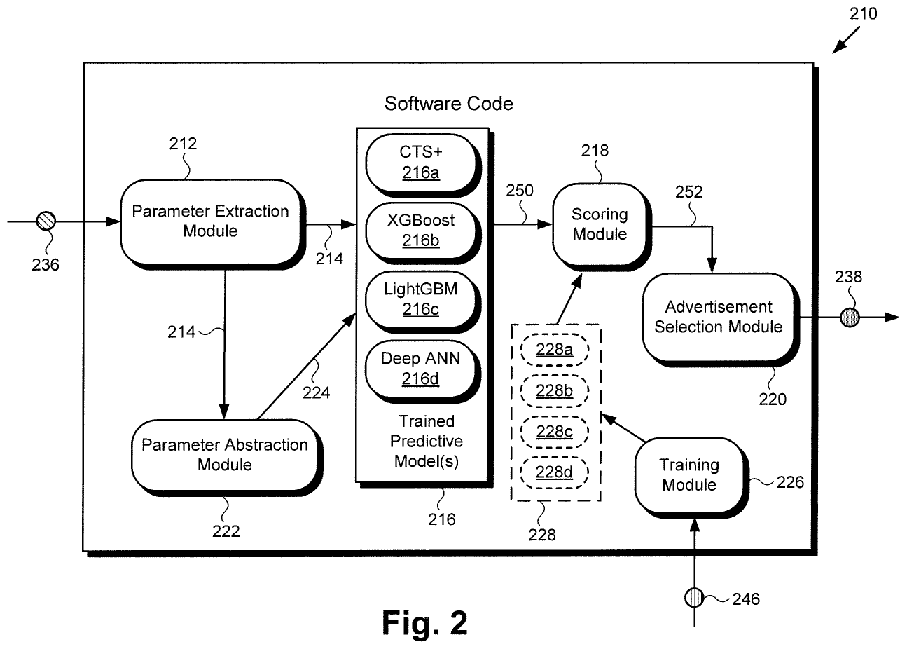

It is further noted that although FIG. 1 depicts software code 110 as being stored in its entirety on a single computing platform, that representation is also merely provided as an aid to conceptual clarity. More generally, system 100 may include one or more computing platforms, such as computer servers for example, which may be co-located, or may form an interactively linked but distributed system, such as a cloud-based system, for instance. As a result, hardware processor 104 and system memory 106 may correspond to distributed processor and memory resources within system 100. Consequently, it is to be understood that the various features of software code 110 shown in FIG. 2 and described below may be stored remotely from one another within the distributed memory resources of system 100.

Computing platform 102 may correspond to one or more web servers, accessible over a packet-switched network such as the Internet, for example. Alternatively, computing platform 102 may correspond to one or more computer servers supporting a wide area network (WAN), a local area network (LAN), or included in another type of private or limited distribution network.

It is also noted that although user system 130 is shown as a desktop computer in FIG. 1, that representation is provided merely as an example as well. More generally, user system 130 may be any suitable mobile or stationary computing device or system that implements data processing capabilities sufficient to provide a user interface, support connections to communication network 108, and implement the functionality ascribed to user system 130 herein. For example, in other implementations, user system 130 may take the form of a laptop computer, tablet computer, or smartphone, for example. Moreover, display 132 of user system 130 may be implemented as a liquid crystal display (LCD), a light-emitting diode (LED) display, an organic light-emitting diode (OLED) display, or any other suitable display screen that performs a physical transformation of signals to light.

FIG. 2 shows exemplary software code 210 suitable for execution by hardware processor 104 of computing platform 102, in FIG. 1, according to one implementation. As shown in FIG. 2, software code 210 may include one or more trained predictive models 216 (hereinafter “trained predictive model(s) 216”). In addition, FIG. 2 shows advertisement selection 238 output by software code 210 in response to advertising query 236 received by software code 210. Also shown in FIG. 2 is consumer rating 246 obtained by software code 210 after distribution of an advertisement based on advertisement selection 238.

Advertising query 236 may correspond in general to first advertising query 136a and/or second advertising query 136b, in FIG. 1, while advertisement selection 238 may correspond in general to first advertisement selection 138a and/or second advertisement selection 138b. Moreover, consumer rating 246, in FIG. 2, corresponds in general to consumer rating 146, in FIG. 1. Thus, first and second advertising queries 136a and 136b, first and second advertisement selections 138a and 138b, and consumer rating 146 may share any of the characteristics attributed to respective advertising query 236, advertisement selection 238, and consumer rating 246 by the present disclosure, and vice versa.

As further shown in FIG. 2, in addition to trained predictive model(s) 216, software code 210 can also include parameter extraction module 212, parameter abstraction module 222, scoring module 218, and advertisement selection module 220 providing advertisement selection 238 as an output. Software code 210 may also include training module 226 for training one or more new predictive models 228 (hereinafter “new predictive model(s) 228”). FIG. 2 further shows parameters 214 extracted from advertising query 236, abstracted parameters 224, candidate advertisements 250 identified using trained predictive model(s) 216, and desirability scores 252 determined for each of candidate advertisements 250 using scoring module 218.

As also shown in FIG. 2, trained predictive model(s) 216 may include one or more of exemplary enhanced Contextual Treatment Selection model 216a (hereinafter “CTS+ model 216a”), eXtreme Gradient Boost model 216b (hereinafter “XGBoost model 216b”), Light Gradient Boosting Machine model 216c (hereinafter “LightGBM model 216c”), and deep ANN 216d. Moreover, it is noted that new predictive model(s) 228 may include one or more of newly trained CTS+ model 228a, XGBoost model 228b, LightGBM model 228c, and deep ANN 228d.

It is further noted that the specific predictive models shown to be included among trained predictive model(s) 216 and new predictive model(s) 228 are merely exemplary, and in other implementations, trained predictive model(s) 216 and new predictive model(s) 228 may include more, or fewer, models than respective CTS+ models 216a and 228a, respective XGBoost models 216b and 228b, respective LightGBM models 216c and 228c, and respective deep ANNs 216d and 228d. Furthermore, in other implementations, trained predictive model(s) 216 and new predictive model(s) 228 may include one or more predictive models other than respective CTS+ models 216a and 228a, respective XGBoost models 216b and 228b, respective LightGBM models 216c and 228c, and respective deep ANNs 216d and 228d.

With respect to CTS+ models 216a and 228a, it is noted that those models may be an enhanced version of the CTS model known in the art. CTS+ and unenhanced CTS are tree-based models that incorporate splitting and termination rules. In general, the CTS+ tree-construction procedure includes a splitting criterion that explicitly optimizes the performance of the tree as measured on the training data. This idea is in line with the machine learning philosophy of loss minimization on the training set. CTS+ uses an ensemble of trees to mitigate the overfitting problem that commonly happens with a single tree.

CTS in its unenhanced form is described in the publication titled “Uplift Modeling with Multiple Treatments and General Response Types,” by Zhao, Fang and Simchi-Levi (see Zhao Y., X. Fang and D. Simchi-Levi, SIAM Data Mining 2017), which is hereby incorporated fully by reference into the present application. In the publication by Zhao et al. incorporated by reference herein, the performance of unenhanced CTS was tested on three benchmark data sets. The first was a 50-dimensional synthetic data set. The latter two were randomized experimental data. According to Zhao et al., on all of the data sets, unenhanced CTS demonstrated superior performance compared to other applicable methods, such as Separate Model Approach with Random Forest/Support Vector, Regression/K-Nearest Neighbors/AdaBoost, and Uplift Random Forest (upliftRF) as implemented in the R uplift package.

By contrast to unenhanced CTS, the enhanced version CTS+ introduced in the present application incorporates use of a weighted impurity function as a component for scoring of candidate advertisements 250 identified by trained CTS+ model 216a. In exemplary implementations, trained CTS+ model 216a including the new weighted impurity function may be implemented in a convenient computer language, such as Python for example, and may be embedded into a machine learning package, such as a scikit-learn package.

Referring to exemplary XGBoost models 216b and 228b, it is noted that XGBoost is an optimized distributed gradient boosting library designed to be highly efficient, flexible, and portable. XGBoost implements machine learning algorithms under the Gradient Boosting framework. XGBoost provides a parallel tree boosting (also known as GBDT, GBM) that solves many data science problems in a fast and accurate way. Documentation describing XGBoost is accessible online at https://xgboostreadthedocsio/en/latest/, and that documentation is hereby incorporated fully by reference into the present application.

Referring to exemplary LightGBM models 216c and 228c, LightGBM is a gradient boosting framework that uses tree based learning algorithms. LightGBM is designed to be distributed and efficient with the following advantages: faster training speed and higher efficiency, lower memory usage, improved accuracy, parallel and GPU learning supported, and capable of handling large-scale data. Documentation describing LightGBM is accessible online at https://lightgbm.readthedocsio/en/latest/, and that documentation is hereby incorporated fully by reference into the present application.

Regarding deep ANNs 216d and 228d, it is noted that such neural network models may be developed utilizing a PyTorch package, which is an optimized tensor library for deep learning using GPUs and CPUs. Documentation describing PyTorch is accessible online at https://pytorch.org/docs/stable/index.html, and that documentation is hereby incorporated fully by reference into the present application.

Software code 210 corresponds in general to software code 110, and those corresponding features may share any of the characteristics attributed to either corresponding feature by the present disclosure. Thus, like software code 210, software code 110 may include predictive model(s) 216, as well as features corresponding respectively to parameter extraction module 212, parameter abstraction module 222, scoring module 218, advertisement selection module 220, training module 226, and new predictive model(s) 228. Moreover, like software code 210, software code 110 may include parameters 214 extracted from advertising query 236, abstracted parameters 224, candidate advertisements 250 identified using trained predictive model(s) 216, and desirability scores 252 determined for each of candidate advertisements 250 using scoring module 218.

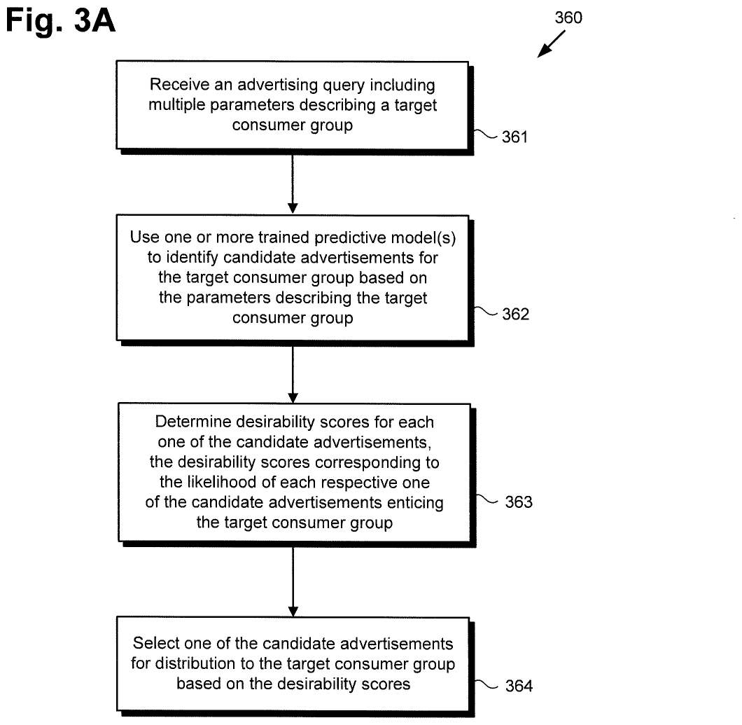

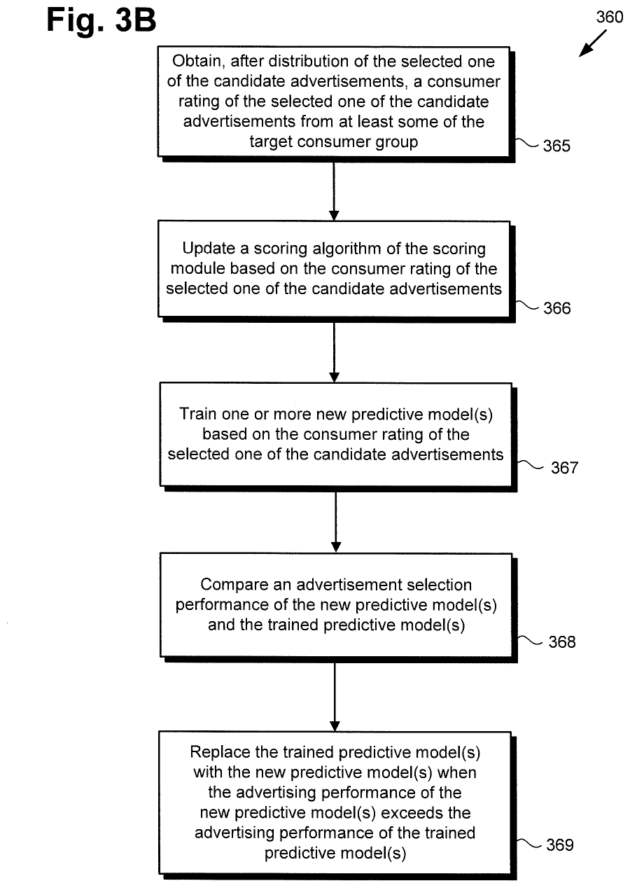

The functionality of software code 110/210 will be further described by reference to FIGS. 3A and 3B in combination with FIGS. 1 and 2. FIG. 3A shows flowchart 360 presenting an exemplary method for use by system 100 for automating advertisement selection using predictive model(s) 216, according to one implementation, while FIG. 3B shows exemplary additional actions extending the exemplary method outlined in FIG. 3A. With respect to the method outlined in FIGS. 3A and 3B, it is noted that certain details and features have been left out of flowchart 360 in order not to obscure the discussion of the inventive features in the present application.

Referring now to FIG. 3A in combination with FIGS. 1 and 2, flowchart 360 begins with receiving first advertising query 136a/236, which includes multiple parameters 214 describing target consumer group 144 (action 361). Parameters 214 may describe target consumer group 144 in terms of age, gender, known consumer activities or affiliations, or other demographic characteristics, for example. Alternatively, or in addition, parameters 214 may include a geographical location or region common to target consumer group 144, the type of content, such as comedy, drama, or sports to be accompanied by an advertisement selected by system 100, temporal aspects such as the time of day or evening during the which the advertisement is to be distributed, and/or business rules related to those parameters. First advertising query 136a/236 including parameters 214 describing target consumer group 144 may be received by software code 110/210, executed by hardware processor 104 of computing platform 102.

Flowchart 360 continues with identifying, using trained predictive model(s) 216, multiple candidate advertisements 250 for target consumer group 144 based on parameters 214 describing target consumer group 144 (action 362). Hardware processor 104 may execute software code 110/210 to utilize parameter extraction module 212 to extract raw parameters 214 described above from first advertising query 136a/236. In some implementations, action 362 may be performed using trained predictive model(s) 216 based solely on parameters 214 extracted from first advertising query 136a/236. However, in other implementations, action 362 may be performed based on abstracted parameters 224 in addition to, or instead of, parameters 214.

Abstracted parameters 224 may be generated using parameter abstraction module 222 of software code 110/210 based on parameters 214. For example, parameter abstraction module 222 may be implemented using an ANN trained using labeled or unlabeled data to infer or “abstract” parameters not expressly included in first advertising query 136a/236. Thus, in some implementations, parameter abstraction module 222 may receive parameters 214 from parameter extraction module 212 as inputs, and may provide abstracted parameters 224 based on parameters 214 as outputs to trained predictive model(s) 216. It is emphasized that, in various implementations, the identification of multiple candidate advertisements 250 in action 362 using trained predictive model(s) 216 may be based on parameters 214 alone, may be based on abstracted parameters 224 alone, or may be based on a combination of parameters 214 and abstracted parameters 224.

As discussed above, trained predictive model(s) may include one or more predictive models. Moreover, those trained predictive models may be used sequentially, in parallel, or selectively. That is to say, in some implementations, multiple predictive models of trained predictive model(s) 216 may be used in action 362, while in other implementations, as few as one of trained predictive model(s) 216 may be used in action 362.

In some implementations, trained predictive model(s) 216 used in action 362 may include a tree-based model that incorporates splitting and termination rules modified by a weighted impurity function, such as CTS+ model 216a. In other words, such a tree-based model may be a CTS model utilizing the weighted impurity function discussed above. In some implementations, trained predictive model(s) 216 used in action 362 may include a substantially optimized distributed gradient boosting library model providing a parallel tree boosting, such as exemplary XGBoost model 216b.

In addition, or alternatively, in some implementations, trained predictive model(s) 216 used in action 362 may include a gradient boosting framework using tree-based learning algorithms, such as exemplary LightGBM model 216c. Moreover, in some implementations, trained predictive model(s) 216 used in action 362 may include deep ANN 216d. Identification of candidate advertisements 250 for target consumer group 144 using trained predictive model(s) 216 may be performed by software code 110/210, executed by hardware processor 104.

Flowchart 360 continues with determining, using scoring module 218, desirability scores 252 for each one of candidate advertisements 250. Each of desirability scores 252 corresponds to the likelihood that the respective one of candidate advertisements 250 (based on which the desirability score is determined) will be enticing to target consumer group 144 (action 363). In other words, each of desirability scores 252 corresponds to the likelihood that the respective one of candidate advertisements 250 will contribute positively to brand lift. Scoring module 218 may be configured to determine desirability scores 252 using a scoring algorithm. For example, in some implementations, scoring module 218 may be configured to determine desirability scores 252 using a scoring algorithm in the form of a cumulative distribution function (CDF), as described in greater detail below. Moreover, in some implementations, desirability scores 252, once determined using scoring module 218, may be utilized to update the CDF or other scoring algorithm. Determination of desirability scores 252 for each one of candidate advertisements 250 using scoring module 218 may be performed by software code 110/210, executed by hardware processor 104.

A CDF is a group statistics that traditionally requires the use of all available data points for its calculation. This requirement that the data used in determining CDF be substantially comprehensive can be extremely burdensome when using a traditional CDF algorithm to analyze an advertising campaign lasting weeks or months. As a result, in some implementations, it may be advantageous or desirable to utilize a fast CDF algorithm (hereinafter “fast CDF”) to approximate quantiles. An example of fast CDF is described in the publication titled “A Fast Algorithm for Approximate Quantiles in High Speed Data Streams,” by Qi Zhang and Wei Wang, (International Conference on Scientific and Statistical Database Management 2007), which is hereby incorporated fully by reference into the present application.

CDF, whether implemented using a traditional CDF algorithm or fast CDF, is utilized herein to calculate the relative scores, i.e., user quality metrics compared with other in-target audience of the same advertising campaigns. Predictions output by trained predictive model(s) 216 are the absolute user quality scores, and those absolute user quality scores are used to calculate CDF for each individual advertising campaign. Each user's absolute user quality score is compared against her/his in-target campaign's CDF to determine the relative user quality score (i.e., approximate quantile), and that relative user quality score is used to determine whether a particular user is admitted to a target consumer group 144 and served an advertisement.

Flowchart 360 can conclude with selecting one of candidate advertisements 250 based on desirability scores 252 for distribution to target consumer group 144 (action 364). For example, in one implementation, the one of candidate advertisements 250 having the highest desirability score 252 determined in action 363 may be selected for distribution to target consumer group 144. Selection of the one of candidate advertisements 250 for distribution to target consumer group 144 based on desirability scores 252 may be performed by software code 110/210, executed by hardware processor 104, and using advertisement selection module 220.

Action 364 results in first advertisement selection 138a/238 being provided as an output by software code 110/210 in response to receiving first advertising query 136a/236 as an input in action 361. As noted above, in some implementations, system 100 may utilize software code to output first advertisement selection 138a/238 in real-time with respect to receiving first advertising query 136a/236 from user 134, such as within less than or equal to one minute, for example, within less than or equal to 500 milliseconds of receiving first advertising query 136a/236.

As shown in FIG. 1, first advertisement selection 138a/238 may be transmitted by system 100 to advertisement server 140, via communication network 108 and network communication links 118. Advertisement 142 identified by first advertisement selection 138a/238 may be distributed to target consumer group 144 by advertisement server 140.

Referring to FIG. 3B, in some implementations, the method outlined in flowchart 360 can be extended to include obtaining, after distribution of the selected one of candidate advertisements 250 identified by first advertisement selection 138a/238 as advertisement 142, consumer rating 146/246 of advertisement 142 from at least some members of target consumer group 144 (action 365). Consumer rating 146/246 may be measured via single question pulse surveys, for example, measuring high level consumer perceptions of advertising experiences. Such a pulse survey, also termed a “sentiment survey” may be prompted after one of target consumer group 144 finishes an advertisement. The pulse survey has to be responded to within a brief time interval, such as 5 seconds, for example. Otherwise, the question being posed in the pulse survey may fade out. The purpose of a pulse survey is to obtain direct, and immediate “consumer ratings” from viewers of advertisements. For instance, the single question “How did you feel about this ad?” may be accompanied by selectable ideograms corresponding respectively to favorable and unfavorable responses to advertisement 142, such as a selectable smiling face and an alternatively selectable frowning face.

Alternatively, or in addition, a more comprehensive survey may be utilized for consumer rating 146/246. For example, such a survey may take the form of a full-blown questionnaire with multiple questions (e.g., dozens of questions) that was prompted by API calls to a third party survey vendors, or may be a series of predetermined questions distributed to target consumer group 144. Consumer rating 146/246 measures brand lift metrics, which are the ultimate campaign performance reports later provided to advertising clients. Distribution of these more comprehensive surveys may be delayed such that consumer rating 146/246 collected in this way may be obtained well after one of target consumer group 144 finishes viewing an advertisement. For example, distribution of a more comprehensive survey may occur as soon as a few minutes to as late as a few weeks after one of target consumer group 144 finishes viewing an advertisement.

Obtaining consumer rating 146/246 in action 365 can be a large volume, low cost indicator of effectiveness of advertisement 142 usable in real-time. Additionally, there may be a strong correlation between consumer rating 146/246 and consumer perception of a brand identified with advertisement 142. Consumer rating 146/246 of advertisement 142 may be obtained from at least some of target consumer group 144 by software code 110/210, executed by hardware processor 104, via communication network 108 and network communication links 118.

As noted above, in some implementations, scoring module 218 of software code 110/210 may utilize a scoring algorithm in the form of a CDF to determine desirability scores 252 for candidate advertisements 250 identified by trained predictive model(s) 216. In some of those implementations, flowchart 360 may further include periodically updating the CDF or other scoring algorithm used, based on consumer rating 146/246 of the selected one of candidate advertisements 250 distributed as advertisement 142 (action 366). For example, in various implementations, a CDF or other scoring algorithm used by scoring module 218 may be updated daily, i.e., every twenty-four hours, every other day, twice daily, or using any other time interval, based on consumer ratings 146/246 obtained since the previous update of the CDF or other scoring algorithm. Action 366 may be performed by software code 110/210, executed by hardware processor 104.

In addition to action 366, or as an alternative action, consumer rating 146/246 obtained in action 365 may be used to train new predictive model(s) 228 (action 367). New predictive model(s) 228 may be trained based using consumer rating 146/246 in a manner analogous to that used for initial training of trained predictive model(s) 216. It is noted that consumer rating 146/246 obtained from pulse surveys and consumer rating 146/246 obtained from more comprehensive questionnaire-type surveys may be used for new model training. Training of new predictive model(s) 228 may be performed by software code 110/210, executed by hardware processor 104, and using training module 226.

In implementations in which new predictive model(s) 228 is/are trained based on consumer rating 146/246, flowchart 360 may continue with comparing the advertisement selection performance of new predictive model(s) 228 to the advertisement selection performance of trained predictive model(s) 216 (action 368). It is also noted that consumer rating 146/246 obtained from pulse surveys and consumer rating 146/246 obtained from more comprehensive questionnaire-type surveys may be used for comparison of the advertisement selection performance of new predictive model(s) 228 to that of trained predictive model(s) 216. Moreover, in those implementations, flowchart 360 may conclude with replacing trained predictive model(s) 216 with new predictive model(s) 228 when the advertisement selection performance of new predictive model(s) 228 exceeds the advertisement selection performance of trained predictive model(s) 216, or exceeds a predetermined threshold (action 369).

Actions 368 and 369 may be performed by software code 110/210, executed by hardware processor 104, and using scoring module 218. By way of example, in some implementations, actions 368 and 369 may be performed periodically, such as daily, weekly, or monthly, to progressively improve the automated advertisement selection performance of system 100. It is noted that when trained predictive model(s) 216 are replaced by new predictive model(s) 228, the scoring algorithm used by scoring module 218 in conjunction with trained predictive model(s) 216 must also be updated or replaced with a scoring algorithm, such as a CDF, optimized for new predictive model(s) 228.

Although not included in the outline provided by flowchart 360, in some implementations, hardware processor 104 may execute software code 110/210 to identify, based on desirability scores 252 for each of candidate advertisements 250, a best predictive model for target consumer group 144 from among trained predictive model(s) 216 or new predictive model(s) 228. In those implementations, upon receiving second advertising query 136b/236 corresponding to target consumer group 144, hardware processor may execute software code to use the identified best predictive model of trained predictive model(s) 216 or new predictive model(s) 228 and scoring module 218 to output second advertisement selection 138b/238 identifying another advertisement for distribution to target consumer group 144. That is to say, where one of trained predictive model(s) 216 or new predictive model(s) 228 is identified as the best predictive model for target consumer group 144, that predictive model may be used as the default predictive model for selecting advertisements for target consumer group 144 until a still better predictive model is identified.

With respect to advertisement 142 identified by first advertisement selection 138a/238, as noted above, advertisement 142 may be transmitted via communication network 108 to user system 130 including display 132. Although not included in the outline provided by flowchart 360, in some implementations in which advertisement 142 is distributed to user system 130, the present method can include rendering advertisement 142 on display 132 of user system 130. As further noted above, display 132 may be implemented as an LCD, LED display, or an OLED display, for example.

In some implementations, user system 130 including display 132 may be integrated with system 100 such that display 132 may be controlled by hardware processor 104 of computing platform 102. In other implementations, software code 110/210 may be stored on a computer-readable non-transitory medium, as discussed above by reference to FIG. 1, and may be accessible to the hardware processing resources of user system 130. In those implementations, the rendering of advertisement 142 on display 132 may be performed by software code 110/210, executed either by hardware processor 104 of computing platform 102, or by a hardware processor of user system 130.

Thus, the present application discloses systems and methods for automating advertisement selection using a predictive model that overcome the drawbacks and deficiencies in the conventional art. Moreover, in some implementations, the automated solutions disclosed by the present application can advantageously provide one or more advertisement selections to a user in real-time with respect to receiving an advertisement query from the user.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. An automated advertisement selection system comprising:
a computing platform including a hardware processor and a system memory;
a software code stored in the system memory, the software code including a trained predictive model and a scoring module;
the hardware processor configured to execute the software code to:
receive an advertising query, the advertising query including a plurality of parameters describing a target consumer group;
identify, using the trained predictive model, a plurality of candidate advertisements for the target consumer group based on the plurality of parameters;
determine, using the scoring module, desirability scores for each one of the plurality of candidate advertisements, each of the desirability scores corresponding to a likelihood of each respective one of the plurality of candidate advertisements enticing the target consumer group; and
select one of the plurality of candidate advertisements based on the desirability scores for distribution to the target consumer group.

2. The automated advertisement selection system of claim 1, wherein the trained predictive model comprises a tree-based model that incorporates splitting and termination rules modified by a weighted impurity function.

3. The automated advertisement selection system of claim 2, wherein the tree-based model comprises a Contextual Treatment Selection (CTS) model utilizing the weighted impurity function.

4. The automated advertisement selection system of claim 1, wherein the trained predictive model comprises a substantially optimized distributed gradient boosting library model providing a parallel tree boosting.

5. The automated advertisement selection system of claim 1, wherein the trained predictive model comprises a gradient boosting framework using tree-based learning algorithms.

6. The automated advertisement selection system of claim 1, wherein the trained predictive model comprises a deep artificial neural network (ANN).

7. The automated advertisement selection system of claim 1, wherein the scoring module is configured to determine the desirability scores using a cumulative distribution function (CDF).

8. The automated advertisement selection system of claim 7, wherein the hardware processor is configured to execute the software code to further:
obtain, after distribution of the selected one of the plurality of candidate advertisements, a consumer rating of the selected one of the plurality of candidate advertisements from at least some members of the target consumer group; and
update the CDF used based on the consumer rating of the selected one of the plurality of candidate advertisements.

9. The automated advertisement selection system of claim 1, wherein the hardware processor is configured to execute the software code to further:
obtain, after distribution of the selected one of the plurality of candidate advertisements, a consumer rating of the selected one of the plurality of candidate advertisements from at least some members of the target consumer group;
train a new predictive model based on the consumer rating of the selected one of the plurality of candidate advertisements;
compare an advertisement selection performance of the new predictive model and the trained predictive model; and
replace the trained predictive model with the new predictive model when the advertisement selection performance of the new predictive model exceeds the advertisement selection performance of the trained predictive model.

10. The automated advertisement selection system of claim 1, wherein the trained predictive model is one of a plurality of trained predictive models, and wherein the hardware processor is configured to execute the software code to further:
identify, based on the desirability scores for each of the plurality of candidate advertisements, a best predictive model for the target consumer group from among the plurality of trained predictive models;
receive another advertising query corresponding to the target consumer group; and
select, using the identified best predictive model and the scoring module, another advertisement for distribution to the target consumer group.

11. A method for use by an automated advertisement selection system including a computing platform having a hardware processor and a system memory, the system memory including a trained predictive model and a scoring module, the method comprising:
receiving, by the software code executed by the hardware processor, an advertising query, the advertising query including a plurality of parameters describing a target consumer group;
identifying, by the software code executed by the hardware processor and using the trained predictive model, a plurality of candidate advertisements for the target consumer group based on the plurality of parameters;
determining, by the software code executed by the hardware processor and using the scoring module, desirability scores for each one of the plurality of candidate advertisements, the desirability scores corresponding to a likelihood of each respective one of the plurality of candidate advertisements enticing the target consumer group; and
selecting, by the software code executed by the hardware processor, one of the plurality of candidate advertisements based on the desirability scores for distribution to the target consumer group.

12. The method of claim 11, wherein the trained predictive model comprises a tree-based model that incorporates splitting and termination rules modified by a weighted impurity function.

13. The method of claim 12, wherein the tree-based model comprises a Contextual Treatment Selection (CTS) model utilizing the weighted impurity function.

14. The method of claim 11, wherein the trained predictive model comprises a substantially optimized distributed gradient boosting library model providing a parallel tree boosting.

15. The method of claim 11, wherein the trained predictive model comprises a gradient boosting framework using tree-based learning algorithms.

16. The method of claim 11, wherein the trained predictive model comprises a deep artificial neural network (ANN).

17. The method of claim 11, wherein the scoring module is configured to determine the desirability scores using a cumulative distribution function (CDF).

18. The method of claim 17, further comprising:
obtaining, by the software code executed by the hardware processor, after distribution of the selected one of the plurality of candidate advertisements, a consumer rating of the selected one of the plurality of candidate advertisements from at least some members of the target consumer group; and
updating, by the software code executed by the hardware processor, the CDF used based on the consumer rating of the selected one of the plurality of candidate advertisements.

19. The method of claim 11, further comprising:
obtain, by the software code executed by the hardware processor, after distribution of the selected one of the plurality of candidate advertisements, a consumer rating of the selected one of the plurality of candidate advertisements from at least some members of the target consumer group; and
training, by the software code executed by the hardware processor, a new predictive model based on the consumer rating of the selected one of the plurality of candidate advertisements;
comparing, by the software code executed by the hardware processor, an advertisement selection performance of the new predictive model and the trained predictive model; and
replacing, by the software code executed by the hardware processor the trained predictive model with the new predictive model when the advertisement selection performance of the new predictive model exceeds the advertisement selection performance of the trained predictive model.

20. The method of claim 11, wherein the trained predictive model is one of a plurality of trained predictive models, the method further comprising:
identifying, by the software code executed by the hardware processor and based on the desirability score for each of the plurality of candidate advertisements, a best predictive model for the target consumer group from among the plurality of trained predictive models;
receiving, by the software code executed by the hardware processor, another advertising query corresponding to the target consumer group; and
selecting, by the software code executed by the hardware processor and using the identified best predictive model and the scoring module, another advertisement for distribution to the target consumer group.
